(19) United States
(12) Patent Application Publication
(10) Pub. No.: US 2014/0340410 A1
(43) Pub. Date: Nov. 20, 2014

(54) METHOD AND SERVER FOR SHARING GRAPHICS PROCESSING UNIT RESOURCES

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/261,567

(22) Filed: Apr. 25, 2014

(30) Foreign Application Priority Data
May 16, 2013 (TW) 102117330

(51) Int. Cl. G06T 1/20; G06F 3/14

(52) U.S. Cl. CPC G06T 1/20; G06F 3/14
USPC 345/502

(57) ABSTRACT

A method for sharing graphics processing unit (GPU) resources between a first server and a second server, each of the server comprising a video adapter, the adapter comprising a GPU. The second server receives a IP address of the first server, when the first server has a load rate less than the predetermined value and the second server has a load rate greater than the predetermined value; and the second server packages pending image data and transmitting the packaged image data to the first server for processing.

### FIELD

The present disclosure relates to graphic processing technologies in a computer system, specifically to a video adapter controlling system, and method.

### BACKGROUND

A graphics processing unit (GPU), also called a visual processing unit (VPU), is a specialized electronic circuit in a computer designed to rapidly manipulate and alter memory to accelerate the creation of images in a frame buffer intended for output to a display.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a video adapter controlling system based on a network, according to an exemplary embodiment.

FIG. 2 is a flow chart of a method for controlling video adapters of the video adapter controlling system of FIG. 1, according to an exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

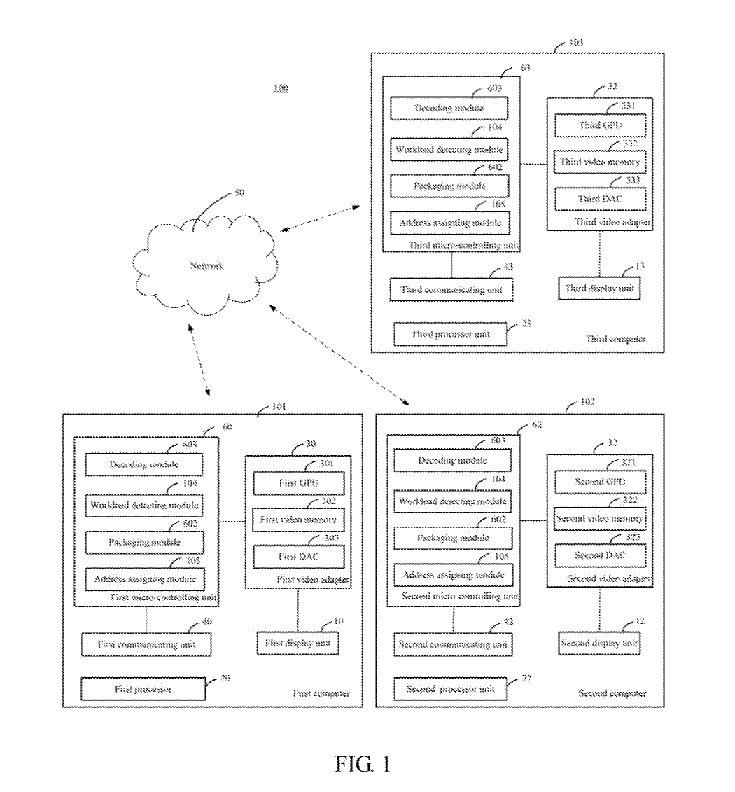

Referring to FIG. 1, a video adapter controlling system 100 in accordance with an embodiment is provided. The video adapter controlling system 100 can be executed on at least two computers. In this embodiment, an example of the video adapter controlling system 100 is executed on three computer systems, for example, a server, personal computer, tablet, etc. A first computer 101, a second computer 102, and a third computer 103 are connected to a network 50. The first computer 101, the second computer 102, and the third computer 103 communicate with each other via the network 50. In this embodiment, the network 50 is the Internet. In other embodiments, the network 50 is a network of mobile Internet or a local area network based on BLUETOOTH, ZIGBEE, WIFI, or other communication technologies.

The first computer 101 includes a first display unit 10, a first processor 20, a first video adapter 30, a first communication unit 40, and a first micro-controlling unit 60. The first processor 20 transfers image data to the first video adapter 30.

The first video adapter 30 includes a first graphics processing unit (GPU) 301, a first video memory 302, and a first digital analog converter (DAC) 303. The first video memory 302 is configured to store pending image data which needs to be processed and stores image data processed by the first GPU 301. In this embodiment, the first video memory 302 is a random-access memory (RAM). The first GPU 301 is configured to process the pending image data stored in the first video memory 302. The first DAC 303 is configured to convert the processed image data to a predetermined format and transmit the data to the first display unit 10. In this embodiment, the predetermined format is a video graphics array (VGA) protocol, the first display unit 10 displays an image accordingly.

The second computer 102 and the third computer 103 are configured similar to the first computer 101. The second computer 102 also includes a second display unit 12, a second processor 22, a communication unit 42, a micro-controlling unit 62, and a second video adapter 32 further including a second GPU 321, a second video memory 322, and a second DAC 323. The third computer 103 also includes a third display unit 13, a third processor 23, a communication unit 43, a micro-controlling unit 63, and a third video adapter 33 further including a third GPU 331, a third video memory 332, and a third DAC 333. Processing completed by the modules in the second computer 102 and in the third computer 103 is completed in a similar method to first computer 101.

A unique media access control address (MAC) can be assigned to each video adapter. In this embodiment, the first video adapter 30 includes a first unique MAC, the second video adapter 32 includes a second unique MAC, and the third video adapter 33 includes a third unique MAC. A unique IP address is assigned to every computer on the network 50, the first computer 101 has a first IP address, the second computer 102 has a second IP address, the third computer 103 has a third IP address.

The video adapter controlling system 100 includes a number of workload detecting modules 104 and address assigning modules 105 respectively being executed on each computer. The workload detecting module 104 is configured to obtain load rates of the first GPU 301, the second GPU 321, and the third GPU 331. The workload detecting module 104 further determines whether the load rate of the each GPU is greater than a predetermined value. The address assigning module 105 is configured to obtain the IP address of each computer. In detail, the address assigning module 105 obtains the first IP address of the first computer 101, the second IP address of the second computer 102, and the third IP address of the third computer 103. The address assigning module 105 further transmits the IP address of a computer which has a load rate less than the predetermined value to a computer which has a load rate greater than the predetermined value.

The video adapter controlling system 100 further includes a number of packaging modules 602 respectively being executed on each computer. When the load rate of the GPU in a computer is greater than a predetermined value, the packaging modules 602 of the computer packages the pending image data stored in the video memory according to the MAC of itself and the received IP address sent by the computer which has a load rate less than the predetermined value, and transmits the packaged image data to that computer.

For example, assuming the load rate of the first GPU 301 is 80%, the load rate of the second GPU 321 is 10%, and the load rate of the third GPU 331 is 20%, and the predetermined value is 33%. The workload detecting module 104 obtains the respective load rates of the GPU 301, the GPU 321, and the GPU 331, and compares the obtained load rates to the predetermined value. In this example, the workload detecting module 104 determines that the load rate of the first GPU 301 is greater than the predetermined value, the load rate of the second GPU 321 is less than the predetermined value, and the load rate of the third GPU 331 is less than the predetermined value.

The address assigning module 105 obtains the first IP address, the second IP address, and the third IP address. The address assigning module 105 transmits the second and third IP addresses to the first computer 101.

In the same example, the load rate of the first GPU 301 in the first computer 101 is greater than the predetermined value. In response to the predetermined value being exceeded, the packaging modules 602 of the first computer 101 packages the pending image data stored in the first video memory 302 into a first IP package, according to the MAC of the first video adapter 30 and the second IP address sent by the address assigning module 105. And the packaging modules 602 of the first computer 101 also packages the pending image data stored in the first video memory 302 into a second IP package according the MAC of the first video adapter 30 and the third IP address. The first IP package containing the second IP address is sent to the second computer 102 and the second IP package containing the third IP address is sent to the third computer 103, all via the network 50.

The second computer 102 receives the first IP package from the network 50 via the second communication unit 42, and extracts the pending image data from the first IP package. The second GPU 321 of the second video adapter 32 processes the pending image data. In the same example, the packaging modules 602 also package the processed image data into an IP package, and the IP package is sent back to the first computer 101 via the network 50. Similarly, the third computer 103 processes the pending image data contained in the second IP package, and transmits the processed image data back to the first computer 101.

Video adapter controlling system 100 shares all the GPU resources among all the computers via network 50.

In another embodiment, the workload detecting module 104, the address assigning module 105 and the packaging modules 602 of the first computer 101 are executed on the micro-controlling unit 60. The first computer 101 works as a host to obtain the IP addresses and load rates of the other computers of the video adapter controlling system 100.

When the load rate of the first GPU 301 in the first computer 101 is greater than the predetermined value, the first computer 101 receives the IP address of a computer which has a lower load rate, as indicated by the address assigning module 105. The packaging modules 602 of the first computer 101 package the pending image data stored in the first video memory 302 into an IP package according the MAC of the first video adapter 30 and the received IP address. The first computer 101 further transmits the IP package to the appropriate computer.

When the load rate of the first GPU 301 in the first computer 101 is less than the predetermined value, the first GPU 301 of first computer 101 processes the pending image data contained in an IP package sent by another computers which has a load rate greater than the predetermined value. The packaging modules 602 of first computer 101 package the processed image data, and the packaged processed image data is sent back to the appropriate computer.

The packaging modules 602 of the second computer 102 execute on the second micro-controlling unit 62. The workflow of the second computer 102 is similar to that of the first computer 101.

The packaging modules 602 of the third computer 103 execute on the third micro-controlling unit 63. The workflow of the second computer 102 is also similar to that of the first computer 101.

The first micro-controlling unit 60, the second micro-controlling unit 62, and the third micro-controlling unit 63 can be field programmable gate arrays (FPGA). In another embodiment, the micro-controlling units can be micro controller chips.

The predetermined value can be set according to the number of the computer contained in the video adapter controlling system 100 and the processing ability of the GPU of each computer.

The video adapter controlling system 100 further includes a number of decoding modules 603 respectively being executed on each computer. When the load rate of the GPU in a computer is less than the predetermined value, the decoding module 603 is configured to extract the pending image data contained in an IP package sent by the other computers and transfer the extracted pending image data to the video memory. When the load rate of the GPU in a computer is greater than the predetermined value, the decoding module 603 is configured to extract the processed image data contained in an IP package sent by the other computers and transfer the extracted processed image data to the video memory.

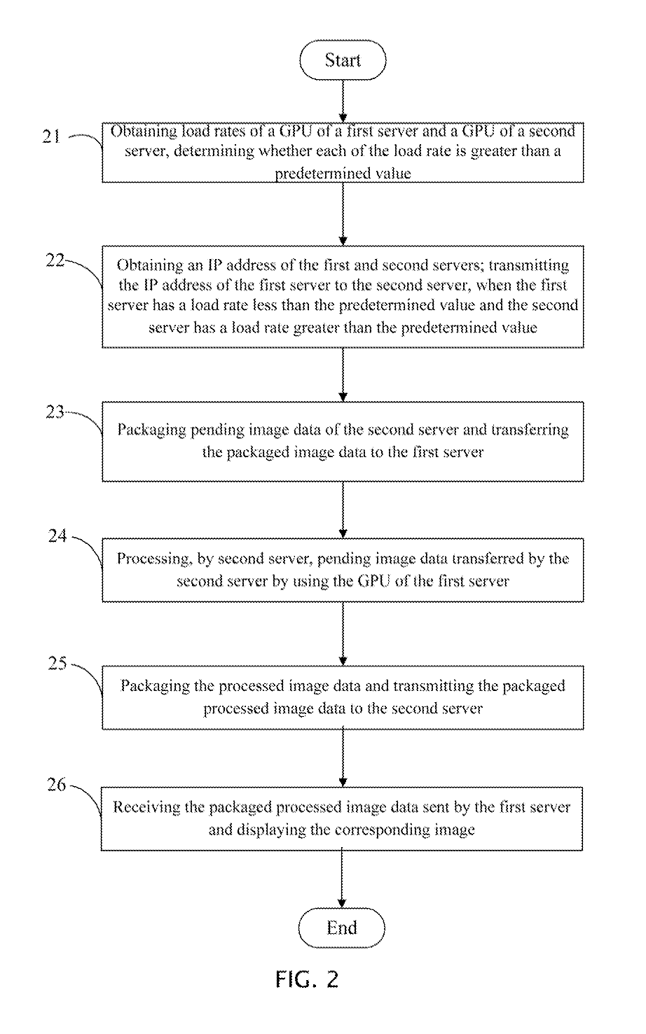

Referring to FIG. 2, a flowchart of an example method for controlling the video adapters applied to the video adapter controlling system 100.

In block 21, obtaining load rates of a GPU of a first server and a GPU of a second server, determining whether each of the load rate is greater than a predetermined value. The workload detecting module 104 obtains load rates of the GPU of the each computer of the video adapter controlling system 100, and determines whether the respective load rate of the GPU is greater than a predetermined value. In detail, the workload detecting module 104 obtains load rates of the first GPU 301, the second GPU 321 and the third GPU 331, and determines whether the load rate of each GPU is greater than a predetermined value.

In block 22, obtaining an IP address of the first and second servers; transmitting the IP address of the first server to the second server, when the first server has a load rate less than the predetermined value and the second server has a load rate greater than the predetermined value. The address assigning module 105 obtains the IP address of each computer of the video adapter controlling system 100, and transmits the IP address of the computer which has a load rate less than the predetermined value to a computer which has a load rate greater than the predetermined value.

The address assigning module 105 obtains the first IP address of the first computer 101, the second IP address of the second computer 102, and the third IP address of the third computer 103. The address assigning module 105 further transmits the IP addresses of computers which have a load rate lower than the predetermined value to a computer which is working on a greater load rate.

In block 23, packaging pending image data of the second server and transferring the packaged image data to the first server. The packaging modules 602 of a computer which has a load rate greater than the predetermined value, packages the pending image data stored in the video memory and transmits the packaged image data to a lower-ratio computer. The packaging modules 602 package the pending image data according to the MAC of the video adapter and the received IP address which has a load rate less than the predetermined value.

In the video adapter controlling system 100, a number of packaging modules 602 run on each computer, the packaging modules 602 of a computer with a greater load rate package the pending image data into an IP package and transmit the IP package to a lower-ratio computer.

In block 24, processing, by second server, pending image data transferred by the second server by using the GPU of the first server. The computer which has a load rate less than the predetermined value receives the packaged image data and processes the pending image data included in the packaged image data.

In the video adapter controlling system 100, when the load rate of the GPU in a computer is less than the predetermined value, the decoding module 603 extracts the received pending image data from the IP package sent by another computer and transfers the extracted pending image data to the video memory for processing.

In block 25, packaging the processed image data and transmitting the packaged processed image data to the second server. The packaging modules 602 of a computer which has a load rate less than the predetermined value package the processed image data and transmit the packaged processed image data back to the computer which is working on a greater load rate. In detail, the packaging modules 602 packages the processed image data into an IP package.

In block 26, receiving the packaged processed image data sent by the first server and displaying the corresponding image. The computer with a greater load rate receives the packaged processed image data and displays the image. The decoding module 603 of the computer with the greater load rate extracts the processed image data from the received IP package sent by another computer and transfers the extracted processed image data to the video memory. The DAC of the video adapter converts the processed image data stored in the video memory into a predetermined format and causes the data to be displayed on the first display unit 10.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for sharing graphics processing unit (GPU) resources, the method comprising:
obtaining load rates of a GPU of a first server and a GPU of a second server;
determining whether each of the load rate is greater than a predetermined value;
obtaining an IP address of the first and second servers;
transmitting the IP address of the first server to the second server, when the first server has a load rate less than the predetermined value and the second server has a load rate greater than the predetermined value;
processing, by second server, pending image data transferred by the second server by using the GPU of the first server; and
packaging the processed image data and transmitting the packaged processed image data to the second server.

2. The method as described in claim 1, further comprising:
extracting the pending image data from the packaged image data sent by the second server;
transferring the extracted pending image data to the video memory for processing; and
processing the pending image data by using the GPU of the first server.

3. A method for sharing graphics processing unit (GPU) resources comprising:
receiving an IP address of a first server, when the first server has a load rate less than the predetermined value and a second server has a load rate greater than the predetermined value; and
packaging pending image data of the second server and transferring the packaged image data to the first server.

4. The method as described in claim 3, further comprising, receiving packaged processed image data sent by the first server and displaying the corresponding image.

5. The method as described in claim 3, further comprising:
packaging pending image data of the second server according the received IP address sent by the first server and transferring the packaged image data to the first server.

6. A first server for sharing graphics processing unit (GPU) resources comprising:
a first display unit;
a first processing unit;
a first micro-controlling unit;
a communicating unit configured to communicate with a second server;
a first video adapter comprising a graphics processing unit (GPU), a video memory configured to store pending image data to be processed and processed image data, and a first digital analog converter (DAC) configured to convert the processed image data to a predetermined format signals and transmit the signals to the first display unit; and
a plurality of storage devices storing a plurality of instructions, which when executed by the first processing unit, causes the first micro-controlling unit to:
obtain load rates of the GPU of the first server and the second server, and determining whether each of the load rate is greater than a predetermined value;
obtain a IP address of the each server of the resource sharing;
transmitting the IP address of the first server to the second server, when the first server has a load rate less than the predetermined value and the second server has a load rate greater than the predetermined value;
receive pending image data transferred by the second server and transfer the pending image data to the video memory for processing; and
package the processed image data and transmit the packaged processed image data to the second server.

7. The first server as described in claim 6, wherein the video memory is a random-access memory (RAM).

8. The first server as described in claim 6, wherein the micro-controlling unit is a field programmable gate array.

9. The first server as described in claim 6, wherein the micro-controlling unit further comprises:
receiving and extracting the pending image data from a packaged image data sent by the second server and transfer the extracted pending image data to the video memory for processing; and
processing the pending image data by using the GPU of the first server.

10. The first server as described in claim 6, wherein the micro-controlling unit further comprising
receiving an IP address of the second server, when the first server has a load rate greater than the predetermined value and the second server has a load rate less than the predetermined value; and
packaging pending image data of the second server and transmitting the packaged image data to the second server.

11. The first server as described in claim 10, wherein the micro-controlling unit further receives packaged processed image data transmitted by the second server and displays the corresponding image

12. The first server as described in claim 10, wherein the micro-controlling unit further packaging pending image data according to the received IP address transmitted by the second server and transmits the packaged image data to the second server.
